(19) United States
(12) Patent Application Publication
(10) Pub. No.: US 2022/0156604 A1
(43) Pub. Date: May 19, 2022

(54) IDENTIFICATION OF COMPARTMENTS IN GAS RESERVOIRS

(71) Applicant: Saudi Arabian Oil Company, Dhahran (SA)

(72) Inventors: Hashim A. Shaikh Sulaiman, Safwa (SA); Hassan Mohammed Alhussain, Dammam (SA); Ayoub Aneddame, Dhahran (SA); Munther M. Alsulaiman, Qatif (SA)

(21) Appl. No.: 16/950,534

(22) Filed: Nov. 17, 2020

(51) Int. Cl. G06N 5/04; G06N 20/00; G01V 99/00

(52) U.S. Cl. CPC G06N 5/04; G01V 99/005; G06N 20/00

(57) ABSTRACT

Disclosed are methods, systems, and computer-readable medium to perform operations including generating a material balance plot for a plurality of wells in a gas reservoir. The material balance plot includes, for each of the plurality of wells, respective static pressure/compressibility factor (P/Z) values plotted against cumulative production in the gas reservoir. The operations further include calculating, for each of the plurality of wells, a respective slope of the respective P/Z values plotted against cumulative production. Also, the operations include grouping, based on the respective slopes and locations of the plurality of wells, each well into a respective cluster. Additionally, the operations include designating each respective cluster as a separate compartment in the gas reservoir.

### TECHNICAL FIELD

This disclosure relates to identification of compartments in gas reservoirs.

### BACKGROUND

In hydrocarbon exploration, the material balance technique is used to determine original fluids-in-place (OFIP) in a reservoir based on reservoir production and reservoir pressure. This technique assumes that the reservoir behaves as a tank with a single trend of reservoir pressure at a specific datum depth.

### SUMMARY

When applied to a gas reservoir, the material balance technique calculates the original gas-in-place (OGIP) of the reservoir, which is the total quantity of natural gas in the reservoir. Specifically, the material balance technique uses a gas material balance equation that represents a relationship between a ratio of static pressure (P) to a compressibility factor (Z) and cumulative gas production in the reservoir. This relationship is assumed to be linear. To calculate OGIP, P/Z values are plotted on a P/Z versus cumulative production graph (also called a material balance plot). The plotted values are fit to a linear line that intercepts the x-axis at OGIP. In some scenarios, such as over-pressured or rich gas-condensate reservoirs, the plot may curve downward, which results in a lower OGIP estimate. In cases of aquifer support, the plot may curve upward, which results in a higher apparent OGIP.

In a compartmentalized reservoir, however, several issues arise that prevent the material balance plot from being used to calculate OGIP. One issue is that multiple P/Z trends can be observed. For example, in low permeability, large heterogeneous reservoirs, the material balance plot does not create a linear relationship even after considerable shut-in time. Therefore, the plot cannot be used for OGIP assessment. Another issue arises in scenarios where sealing or semi-conductive faults, or stratigraphic barriers exist. In such scenarios, a linear relationship might be observed in the material balance plot, but it cannot be used to estimate OGIP.

This disclosure describes methods of using a material balance graphical representation to identify compartments in gas reservoirs. The methods are useful in various reservoirs, such as low permeability heterogeneous reservoirs, because they provide a solution for the scattered P/Z trends that are observed in such formations. More specifically, the methods partition wells of a dataset into groups that are internally homogeneous and externally distinct. This is achieved through an analysis of similarity between the wells based on one or more features that distinguish well behaviors.

In an embodiment, a method uses a material balance graphical representation to identify compartments in a gas reservoir. The input of the method includes the P/Z of wells in the reservoir, field cumulative production, and geographic locations of the wells. A machine learning (ML) algorithm, such as a modified hierarchical clustering algorithm, is used to identify the reservoir compartments based on the input information. More specifically, based on the input data, the ML algorithm merges nearby wells into clusters until a stopping criteria is reached. The stopping criteria is a stopping condition that facilitates choosing an optimal “k” number of clusters. In an example, the criteria is a pressure threshold (tolerance) within each compartment for defined time-step. The criteria is adjustable based on the maturity of the field/reservoir.

Aspects of the subject matter described in this specification may be embodied in methods that include generating a material balance plot for a plurality of wells in a gas reservoir. The material balance plot includes, for each of the plurality of wells, respective static pressure/compressibility factor (P/Z) values plotted against cumulative production in the gas reservoir. The actions further include calculating, for each of the plurality of wells, a respective slope of the respective P/Z values plotted against cumulative production. Also, the actions include grouping, based on the respective slopes and locations of the plurality of wells, each well into a respective cluster. Additionally, the actions include designating each respective cluster as a separate compartment in the gas reservoir.

The previously-described implementation is applicable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other embodiments may each optionally include one or more of the following features.

In some implementations, grouping, based on the respective slopes and locations of the plurality of wells, each well into a respective cluster involves using a machine-learning algorithm to group each well into the respective cluster based on the respective slopes and locations of the plurality of wells.

In some implementations, grouping, based on the respective slopes and locations of the plurality of wells, each well into a respective cluster involves designating each well as a separate cluster; and until a stopping condition is reached, iteratively: calculating a respective proximity matrix of each separate cluster with respect to the other separate clusters based on Euclidean distance; and using a modified clustering algorithm to merge the two most similar separate clusters.

In some implementations, the stopping condition is exceeding a pressure threshold within each separate cluster for a defined time-step.

In some implementations, the methods further involve updating the stopping condition based on an evaluation of each compartment in the reservoir.

In some implementations, using a modified clustering algorithm to merge the two most similar separate clusters involves calculating similarities between each pair of separate clusters; determining, based on the calculated similarities, the two most similar separate clusters; and merging the two most similar separate clusters to form a new cluster.

In some implementations, the methods further involve generating a reservoir map indicative of each separate compartment in the gas reservoir.

The subject matter described in this specification can be implemented to realize one or more of the following advantages. The disclosed methods identify compartments in gas reservoirs. For example, the disclosed methods identify compartments in low permeability gas reservoirs, which are difficult to identify using existing techniques. Further, the disclosed methods help identify stratigraphic/structural barriers separating different reservoir compartments. Additionally, the disclosed methods facilitate qualitative understanding of the transmissibility or connectivity between the identified compartments of the reservoir. The disclosed methods can also be used for regional alteration of parameters in each compartment during a history matching stage of reservoir dynamic simulation modeling. This approach is superior to the alteration around single wells approach of existing techniques.

Furthermore, the disclosed methods can be used to prepare an input for a connected tank (CT) technique in which identification of reservoir compartments is a pre-requisite. The CT technique can be used, for example, for reserve estimation. Additionally, the disclosed methods require fewer input data than existing techniques to identify reservoir compartments. The input data used by the disclosed methods, such as gas cumulative production, static bottom-hole pressure (SBHP) surveys, and the compressibility factor, are commonly reported and used by gas operators.

The details of one or more implementations of the subject matter described in this disclosure are set forth in the accompanying drawings and the description. Other features, aspects, and advantages of the subject matter will become apparent from the description, the drawings, and the claims.

### BRIEF DESCRIPTION OF THE DRAWINGS

FIG. 1 illustrates an example compartment identification system (CIS), according to some implementations of the present disclosure.

FIG. 2 illustrates an example workflow for identifying compartments in a gas reservoir, according to some implementations of the present disclosure.

FIG. 3 illustrates a flowchart of an example method, according to some implementations of the present disclosure.

FIG. 4 illustrates a block diagram of an example computer system, according to some implementations of present disclosure.

Like reference numbers and designations in the various drawings indicate like elements.

### DETAILED DESCRIPTION

This disclosure describes methods and systems for identifying compartments in a gas reservoir. A compartment is a segment of a gas reservoir that has weak or nearly no fluid/pressure connection with other segments of the reservoir. In an embodiment, to identify compartments in a gas reservoir, a method uses a graphical representation of a ratio of static pressure to a compressibility factor (P/Z) of wells in the reservoir. The input to the method includes the P/Z of the wells, locations of the wells, and cumulative production of the reservoir. The method uses an unsupervised machine learning (ML) algorithm (for example, a modified hierarchical clustering algorithm) to identify the reservoir compartments based on the input data. More specifically, the ML algorithm merges nearby wells into clusters until a stopping criteria is reached. Once the stopping criteria is reached, each of the clusters is identified as a respective compartment.

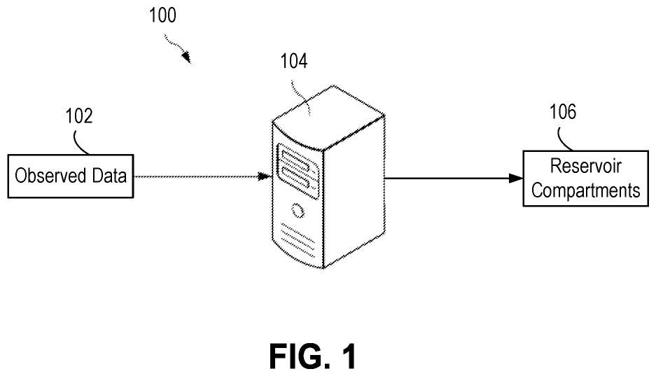

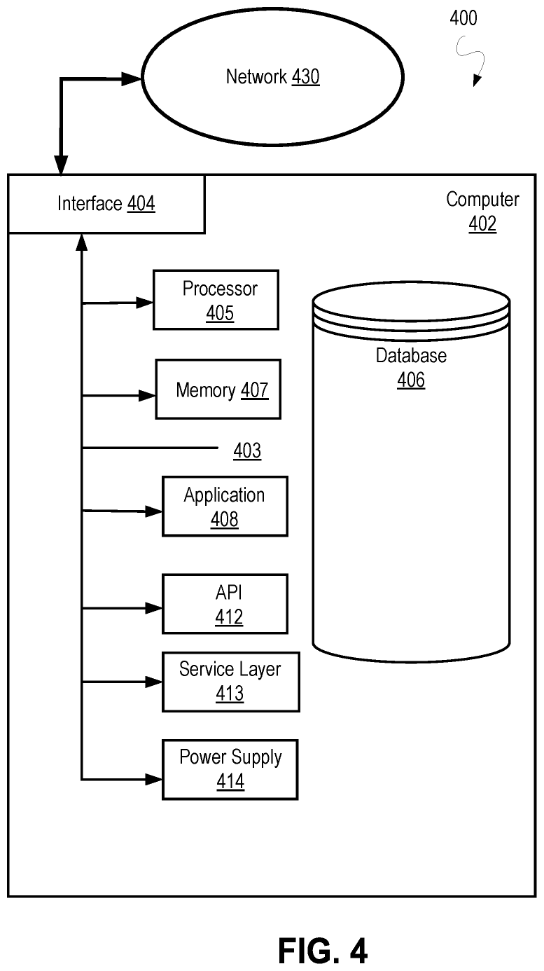

FIG. 1 illustrates an example compartment identification system (CIS) 100, according to some implementations. The CIS 100 includes a computing device 104 that can be in communication with one or more other computing devices (not shown) and data stores (not shown) over one or more networks. The computing device 104 can be implemented using computing system 400 of FIG. 4. As shown in FIG. 1, the computing device 104 receives observed data 102 associated with a gas reservoir. The computing device 104 uses the observed data 102 to generate reservoir compartments 106. The reservoir compartments 106 can take various forms, such as a list of reservoir compartments or a map of reservoir compartments.

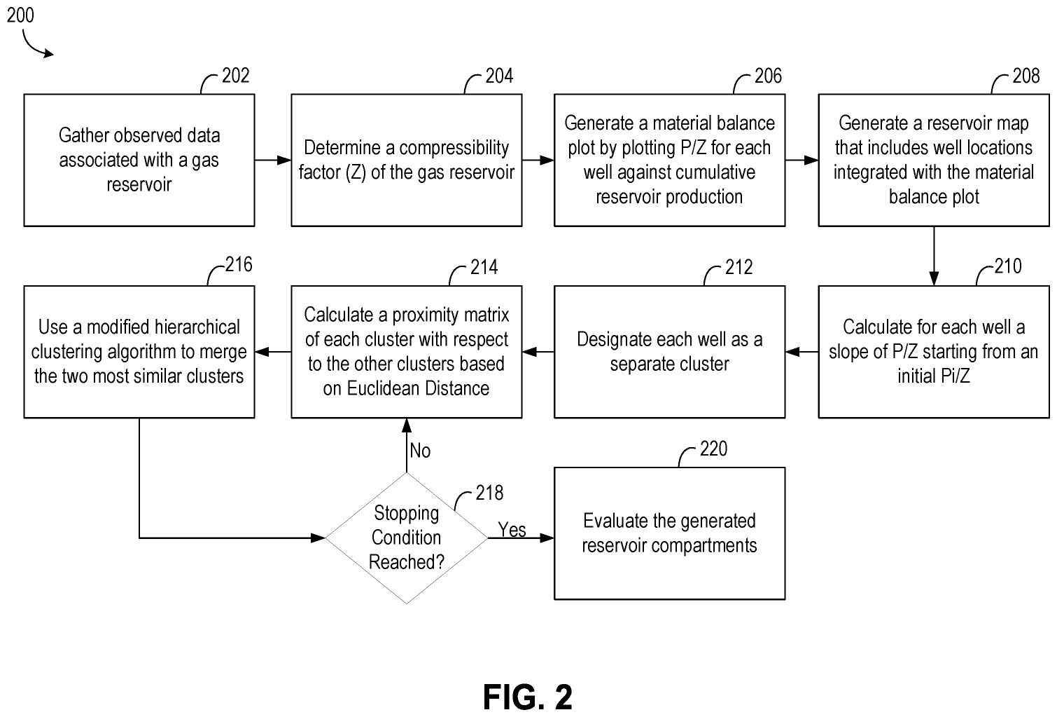

FIG. 2 illustrates an example workflow 200 for identifying compartments in a gas reservoir, according to some implementations. The computing device 104 can perform the workflow 200 in order to identify compartments in a gas reservoir. For clarity of presentation, the description that follows generally describes the workflow 200 in the context of components in other figures of this description. However, it will be understood that the workflow 200 can be performed, for example, by any suitable system, environment, software, hardware, or a combination of systems, environments, software, and hardware, as appropriate. In some implementations, various steps of the workflow 200 can be run in parallel, in combination, in loops, or in any order.

The workflow 200 starts at step 202. At step 202, the computing device 104 gathers observed data associated with a gas reservoir that includes a plurality of wells. The observed data includes gas production per well, pressure data of each well, and geographic coordinates of each well. The pressure data of a well can be static bottom-hole pressure (SBHP), which can be determined from an SBHP survey of the well. In some examples, the pressure data of the plurality of wells is corrected to a single datum depth.

At step 204, the computing device 104 determines a compressibility factor (Z) for the gas reservoir. The compressibility factor for the reservoir can be a compressibility factor curve that is calculated by the computing device 104 using pressure-volume-temperature (PVT) experiments on gas samples from the reservoir. Such PVT experiments can include constant composition expansion (CCE) and constant volume depletion (CVD) experiments. Alternatively, the computing device 104 can receive information indicative of the compressibility factor, perhaps from a user input or an external system.

At step 206, the computing device 104 generates a material balance plot by plotting static pressure/compressibility (P/Z) for each well against cumulative production in the reservoir. In this step, the computing device calculates one or more P/Z values for each well based on the static pressure data of each well and the compressibility factor. The computing device 104 plots each P/Z value against the corresponding cumulative production values of the reservoir to generate the material balance plot. The y-axis of the material balance plot is P/Z and the x-axis is cumulative production. In some examples, the cumulative production is specified in terms of a natural gas equivalent, which refers to the amount of natural gas needed to equal the energy produced from one barrel of crude oil.

At step 208, the computing device 104 generates a reservoir map integrated with the material balance plot. The reservoir map includes a representation of well locations in the reservoir. Additionally, the reservoir map includes a graphical representation of the material balance plot. For example, when a well is selected in the reservoir map, the values corresponding to the well are emphasized in the material balance plot, perhaps using a graphical feature (for example, highlighting, color change, contrast change). Similarly, when a data point is chosen in the material balance plot, the corresponding well is emphasized within the reservoir map. In this way, the reservoir map and the material balance plot are integrated with one another.

At step 210, the computing device 104 calculates for each well a slope of P/Z starting from an initial P/Z value (Pi/Z). In this step, the computing device 104 calculates for each well a slope of a linear line that fits the respective P/Z values of that well. In particular, the slope for a well is calculated using the initial P/Z value for that well (Pi/Z), which may be the y-intercept of the linear line for that well. The slope of the P/Z values of a well is referred to as a P/Z slope of that well.

At step 212, the computing device 104 designates each well as a separate cluster. At step 214, the computing device 104 calculates a proximity matrix of each cluster with respect to the other clusters based on Euclidean distance. The proximity matrix of a cluster is indicative of that cluster's distance to each of the other clusters. In a first iteration of the step 214, the proximity matrix of a cluster is indicative of the Euclidean distance from the cluster's corresponding well to the other wells in the reservoir.

At step 216, the computing device 104 uses a modified clustering algorithm to merge the two most similar clusters. In this step, the computing device 104 uses the modified clustering algorithm to calculate a similarity between each pair of clusters in terms of one or more predetermined features. The one or more features include a distance between the wells (for example, determined from the coordinates of the wells) and P/Z slopes of the wells. In an example, the similarity between a pair of clusters (C₁, C₂) is calculated using Equation (1):

$$s i m ( {C}_{1} , {C}_{2} ) = \sum \frac{s i m ( {W}_{i} , {W}_{j} )}{\vert {C}_{1} \vert * \vert {C}_{2} \vert} \\ where , {W}_{i} ∈ {C}_{1} \& {W}_{j} ∈ {C}_{2} . \qquad Equation ( 1 )$$

In Equation (1), Wᵢ is a well that belongs to cluster 1 (C₁) and Wⱼ is a well that belongs to cluster 2 (C₂). Once the similarities are calculated, the computing device 104 selects the two most similar clusters to be merged into a single cluster. The computing device 104 then merges the two clusters into a single cluster.

At step 218, the computing device 104 determines whether a stopping condition has been reached. The stopping criteria is a stopping condition that allows the computing device 104 to select an optimal “k” number of clusters. In an example, the stopping criteria is a pressure threshold (tolerance) within each cluster for a defined time-step. The defined time-step can be predetermined or provided by user input. The time-step can depend on data frequency, user preference, or both. Note that the pressure threshold is adjustable based on the maturity of the reservoir.

As shown in FIG. 2, if the stopping condition has not been reached, then the computing device 104 returns to step 214 of calculating a proximity matrix of each cluster. Here, given that the proximity matrices have already been generated, the computing device 104 updates the proximity matrices to reflect the merged clusters. Specifically, the computing device 104 updates the proximity matrix associated with each cluster to reflect that the two clusters have been merged. Then, the computing device 104 recalculates the Euclidean distances between each cluster and the new cluster.

Conversely, if the stopping condition has been reached, then the computing device 104 moves to step 220. At step 220, the computing device 104 evaluates the generated reservoir compartments. In this step, the computing device 104 first designates each cluster as a respective reservoir compartment. Then, the computing device evaluates the reservoir compartments. In an example, evaluating the reservoir compartments involves at least one of evaluating the static bottom-hole pressure (SBHP) of the compartments, the compressibility factor of the compartments, pressure transient analysis, or locations of the wells associated with the compartments.

In some examples, the computing device 104 further updates the pressure threshold (that is, the stopping criteria used in step 218) based on the evaluation of the reservoir compartments. In particular, the computing device 104 can update the stopping criteria based on an evaluation of the maturity of the gas reservoir.

Within examples, the generated reservoir compartments can be used in a variety of workflows. As an example, information indicative of the generated reservoir compartments help identify stratigraphic/structural barriers separating different reservoir compartments. Additionally, the generated reservoir compartments enables qualitative understanding of the transmissibility or connectivity between the reservoir compartments. The reservoir compartments can also be used for regional alteration of parameters in each compartment during a history matching stage of reservoir dynamic simulation modeling. Furthermore, the reservoir compartments can be used to prepare an input for a Connected Tank (CT) technique where identification of reservoir compartments is a pre-requisite. The CT technique can be used, for example, for reserve estimation. Yet further, the generated reservoir compartments can be incorporated into the construction of three-dimensional (3D) geological models and assisted history matching of reservoir simulation modeling.

In some examples, the generated reservoir compartments can be represented using visual graphics, such as charts, maps, plots, or graphs. The computing device 104 can be used to display a graphical user interface (GUI) on a display device. In particular, the graphical user interface may use data visualization software that retrieves data from the computing device 104 and generates the data visualization. For example, the computing device 104 can store and execute software, such as an operating system or application modules. Application modules can include routines, programs, objects, components, or data structures that perform particular tasks or that implement particular inventory management functions. In an example, the graphical user interface generates a GUI that shows an interactive map of reservoir compartments. Other examples are possible and are contemplated herein.

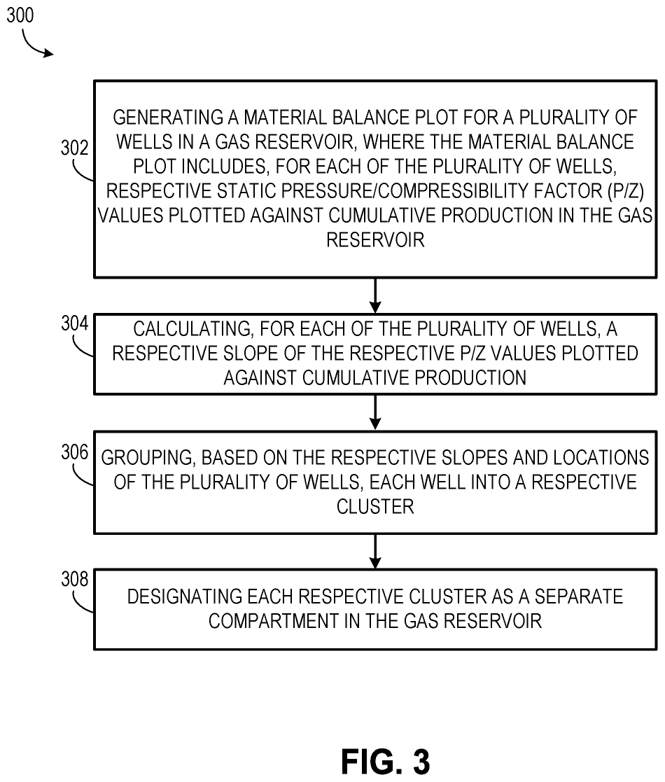

FIG. 3 is a flowchart of an example method 300, according to some implementations. The method 300 is for identifying compartments in a gas reservoir. For clarity of presentation, the description that follows generally describes method 300 in the context of the other figures in this description. However, it will be understood that method 300 can be performed, for example, by any suitable system, environment, software, hardware, or a combination of systems, environments, software, and hardware, as appropriate. In some implementations, various steps of method 300 can be run in parallel, in combination, in loops, or in any order.

At step 302, method 300 involves generating a material balance plot for a plurality of wells in a gas reservoir, where the material balance plot comprises, for each of the plurality of wells, respective static pressure/compressibility factor (P/Z) values plotted against cumulative production in the gas reservoir.

At step 304, method 300 involves calculating, for each of the plurality of wells, a respective slope of the respective P/Z values plotted against cumulative production.

At step 306, method 300 involves grouping, based on the respective slopes and locations of the plurality of wells, each well into a respective cluster.

At step 308, method 300 involves designating each respective cluster as a separate compartment in the gas reservoir.

In some implementations, grouping, based on the respective slopes and locations of the plurality of wells, each well into a respective cluster involves using a machine-learning algorithm to group each well into the respective cluster based on the respective slopes and locations of the plurality of wells.

In some implementations, grouping, based on the respective slopes and locations of the plurality of wells, each well into a respective cluster involves designating each well as a separate cluster; and until a stopping condition is reached, iteratively: calculating a respective proximity matrix of each separate cluster with respect to the other separate clusters based on Euclidean distance; and using a modified clustering algorithm to merge the two most similar separate clusters.

In some implementations, the stopping condition is exceeding a pressure threshold within each separate cluster for a defined time-step.

In some implementations, method 300 further involves updating the stopping condition based on an evaluation of each compartment in the reservoir.

In some implementations, using a modified clustering algorithm to merge the two most similar separate clusters involves calculating similarities between each pair of separate clusters; determining, based on the calculated similarities, the two most similar separate clusters; and merging the two most similar separate clusters to form a new cluster.

In some implementations, method 300 further involves generating a reservoir map indicative of each separate compartment in the gas reservoir.

FIG. 4 is a block diagram of an example computer system 400 that can be used to provide computational functionalities associated with described algorithms, methods, functions, processes, flows, and procedures described in the present disclosure, according to some implementations of the present disclosure. In some implementations, the CIS 100 can be the computer system 400, include the computer system 400, or include part of the computer system 400. In some implementations, the CIS 100 can communicate with the computer system 400.

The illustrated computer 402 is intended to encompass any computing device such as a server, a desktop computer, embedded computer, a laptop/notebook computer, a wireless data port, a smart phone, a personal data assistant (PDA), a tablet computing device, or one or more processors within these devices, including physical instances, virtual instances, or both. The computer 402 can include input devices such as keypads, keyboards, and touch screens that can accept user information. Also, the computer 402 can include output devices that can convey information associated with the operation of the computer 402. The information can include digital data, visual data, audio information, or a combination of information. The information can be presented in a graphical user interface (UI) (or GUI). In some implementations, the inputs and outputs include display ports (such as DVI-I+2x display ports), USB 3.0, GbE ports, isolated DI/O, SATA-III (6.0 Gb/s) ports, mPCIe slots, a combination of these, or other ports. In instances of an edge gateway, the computer 402 can include a Smart Embedded Management Agent (SEMA), such as a built-in ADLINK SEMA 2.2, and a video sync technology, such as Quick Sync Video technology supported by ADLINK MSDK+. In some examples, the computer 402 can include the MXE-5400 Series processor-based fanless embedded computer by ADLINK, though the computer 402 can take other forms or include other components.

The computer 402 can serve in a role as a client, a network component, a server, a database, a persistency, or components of a computer system for performing the subject matter described in the present disclosure. The illustrated computer 402 is communicably coupled with a network 430. In some implementations, one or more components of the computer 402 can be configured to operate within different environments, including cloud-computing-based environments, local environments, global environments, and combinations of environments.

At a high level, the computer 402 is an electronic computing device operable to receive, transmit, process, store, and manage data and information associated with the described subject matter. According to some implementations, the computer 402 can also include, or be communicably coupled with, an application server, an email server, a web server, a caching server, a streaming data server, or a combination of servers.

The computer 402 can receive requests over network 430 from a client application (for example, executing on another computer 402). The computer 402 can respond to the received requests by processing the received requests using software applications. Requests can also be sent to the computer 402 from internal users (for example, from a command console), external (or third) parties, automated applications, entities, individuals, systems, and computers.

Each of the components of the computer 402 can communicate using a system bus. In some implementations, any or all of the components of the computer 402, including hardware or software components, can interface with each other or the interface 404 (or a combination of both), over the system bus. Interfaces can use an application programming interface (API), a service layer, or a combination of the API and service layer. The API can include specifications for routines, data structures, and object classes. The API can be either computer-language independent or dependent. The API can refer to a complete interface, a single function, or a set of APIs.

The service layer can provide software services to the computer 402 and other components (whether illustrated or not) that are communicably coupled to the computer 402. The functionality of the computer 402 can be accessible for all service consumers using this service layer. Software services, such as those provided by the service layer, can provide reusable, defined functionalities through a defined interface. For example, the interface can be software written in JAVA, C++, or a language providing data in extensible markup language (XML) format. While illustrated as an integrated component of the computer 402, in alternative implementations, the API or the service layer can be stand-alone components in relation to other components of the computer 402 and other components communicably coupled to the computer 402. Moreover, any or all parts of the API or the service layer can be implemented as child or sub-modules of another software module, enterprise application, or hardware module without departing from the scope of the present disclosure.

The computer 402 can include an interface 404. Although illustrated as a single interface 404 in FIG. 4, two or more interfaces 404 can be used according to particular needs, desires, or particular implementations of the computer 402 and the described functionality. The interface 404 can be used by the computer 402 for communicating with other systems that are connected to the network 430 (whether illustrated or not) in a distributed environment. Generally, the interface 404 can include, or be implemented using, logic encoded in software or hardware (or a combination of software and hardware) operable to communicate with the network 430. More specifically, the interface 404 can include software supporting one or more communication protocols associated with communications. As such, the network 430 or the interface's hardware can be operable to communicate physical signals within and outside of the illustrated computer 402.

The computer 402 includes a processor 405. Although illustrated as a single processor 405 in FIG. 4, two or more processors 405 can be used according to particular needs, desires, or particular implementations of the computer 402 and the described functionality. Generally, the processor 405 can execute instructions and can manipulate data to perform the operations of the computer 402, including operations using algorithms, methods, functions, processes, flows, and procedures as described in the present disclosure.

The computer 402 can also include a database 406 that can hold data for the computer 402 and other components connected to the network 430 (whether illustrated or not). For example, database 406 can be an in-memory, conventional, or a database storing data consistent with the present disclosure. In some implementations, database 406 can be a combination of two or more different database types (for example, hybrid in-memory and conventional databases) according to particular needs, desires, or particular implementations of the computer 402 and the described functionality. Although illustrated as a single database 406 in FIG. 4, two or more databases (of the same, different, or combination of types) can be used according to particular needs, desires, or particular implementations of the computer 402 and the described functionality. While database 406 is illustrated as an internal component of the computer 402, in alternative implementations, database 406 can be external to the computer 402.

The computer 402 also includes a memory 407 that can hold data for the computer 402 or a combination of components connected to the network 430 (whether illustrated or not). Memory 407 can store any data consistent with the present disclosure. In some implementations, memory 407 can be a combination of two or more different types of memory (for example, a combination of semiconductor and magnetic storage) according to particular needs, desires, or particular implementations of the computer 402 and the described functionality. Although illustrated as a single memory 407 in FIG. 4, two or more memories 407 (of the same, different, or combination of types) can be used according to particular needs, desires, or particular implementations of the computer 402 and the described functionality. While memory 407 is illustrated as an internal component of the computer 402, in alternative implementations, memory 407 can be external to the computer 402.

An application can be an algorithmic software engine providing functionality according to particular needs, desires, or particular implementations of the computer 402 and the described functionality. For example, an application can serve as one or more components, modules, or applications. Multiple applications can be implemented on the computer 402. Each application can be internal or external to the computer 402.

The computer 402 can also include a power supply 414. The power supply 414 can include a rechargeable or non-rechargeable battery that can be configured to be either user- or non-user-replaceable. In some implementations, the power supply 414 can include power-conversion and management circuits, including recharging, standby, and power management functionalities. In some implementations, the power-supply 414 can include a power plug to allow the computer 402 to be plugged into a wall socket or a power source to, for example, power the computer 402 or recharge a rechargeable battery.

There can be any number of computers 402 associated with, or external to, a computer system including computer 402, with each computer 402 communicating over network 430. Further, the terms “client,” “user,” and other appropriate terminology can be used interchangeably, as appropriate, without departing from the scope of the present disclosure. Moreover, the present disclosure contemplates that many users can use one computer 402 and one user can use multiple computers 402.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/-R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification includes many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A method comprising:
generating a material balance plot for a plurality of wells in a gas reservoir, wherein the material balance plot comprises, for each of the plurality of wells, respective static pressure/compressibility factor (P/Z) values plotted against cumulative production in the gas reservoir;
calculating, for each of the plurality of wells, a respective slope of the respective P/Z values plotted against cumulative production;
grouping, based on the respective slopes and locations of the plurality of wells, each well into a respective cluster; and
designating each respective cluster as a separate compartment in the gas reservoir.

2. The method of claim 1, wherein grouping, based on the respective slopes and locations of the plurality of wells, each well into a respective cluster comprises:
using a machine-learning algorithm to group each well into the respective cluster based on the respective slopes and locations of the plurality of wells.

3. The method of claim 1, wherein grouping, based on the respective slopes and locations of the plurality of wells, each well into a respective cluster comprises:
designating each well as a separate cluster; and
until a stopping condition is reached, iteratively:
calculating a respective proximity matrix of each separate cluster with respect to the other separate clusters based on Euclidean distance; and
using a modified clustering algorithm to merge the two most similar separate clusters.

4. The method of claim 3, wherein the stopping condition is exceeding a pressure threshold within each separate cluster for a defined time-step.

5. The method of claim 3, wherein the method further comprises:
updating the stopping condition based on an evaluation of each compartment in the reservoir.

6. The method of claim 3, wherein using a modified clustering algorithm to merge the two most similar separate clusters comprises:
calculating similarities between each pair of separate clusters;
determining, based on the calculated similarities, the two most similar separate clusters; and
merging the two most similar separate clusters to form a new cluster.

7. The method of claim 1, further comprising:
generating a reservoir map indicative of each separate compartment in the gas reservoir; and
displaying the reservoir map on a display device.

8. A non-transitory computer-readable medium storing one or more instructions executable by a computer system to perform operations comprising:
generating a material balance plot for a plurality of wells in a gas reservoir, wherein the material balance plot comprises, for each of the plurality of wells, respective static pressure/compressibility factor (P/Z) values plotted against cumulative production in the gas reservoir;
calculating, for each of the plurality of wells, a respective slope of the respective P/Z values plotted against cumulative production;
grouping, based on the respective slopes and locations of the plurality of wells, each well into a respective cluster; and
designating each respective cluster as a separate compartment in the gas reservoir.

9. The non-transitory computer-readable medium of claim 8, wherein grouping, based on the respective slopes and locations of the plurality of wells, each well into a respective cluster comprises:
using a machine-learning algorithm to group each well into the respective cluster based on the respective slopes and locations of the plurality of wells.

10. The non-transitory computer-readable medium of claim 8, wherein grouping, based on the respective slopes and locations of the plurality of wells, each well into a respective cluster comprises:
designating each well as a separate cluster; and
until a stopping condition is reached, iteratively:
calculating a respective proximity matrix of each separate cluster with respect to the other separate clusters based on Euclidean distance; and
using a modified clustering algorithm to merge the two most similar separate clusters.

11. The non-transitory computer-readable medium of claim 10, wherein the stopping condition is exceeding a pressure threshold within each separate cluster for a defined time-step.

12. The non-transitory computer-readable medium of claim 10, wherein the operations further comprise:
updating the stopping condition based on an evaluation of each compartment in the reservoir.

13. The non-transitory computer-readable medium of claim 10, wherein using a modified clustering algorithm to merge the two most similar separate clusters comprises:
calculating similarities between each pair of separate clusters;
determining, based on the calculated similarities, the two most similar separate clusters; and
merging the two most similar separate clusters to form a new cluster.

14. The non-transitory computer-readable medium of claim 8, the operations further comprising:
generating a reservoir map indicative of each separate compartment in the gas reservoir; and
displaying the reservoir map on a display device.

15. A system, comprising:
one or more processors; and
a non-transitory computer-readable storage medium coupled to the one or more processors and storing programming instructions for execution by the one or more processors, the programming instructions instructing the one or more processors to perform operations comprising:
generating a material balance plot for a plurality of wells in a gas reservoir, wherein the material balance plot comprises, for each of the plurality of wells, respective static pressure/compressibility factor (P/Z) values plotted against cumulative production in the gas reservoir;
calculating, for each of the plurality of wells, a respective slope of the respective P/Z values plotted against cumulative production;
grouping, based on the respective slopes and locations of the plurality of wells, each well into a respective cluster; and
designating each respective cluster as a separate compartment in the gas reservoir.

16. The system of claim 15, wherein grouping, based on the respective slopes and locations of the plurality of wells, each well into a respective cluster comprises:
using a machine-learning algorithm to group each well into the respective cluster based on the respective slopes and locations of the plurality of wells.

17. The system of claim 15, wherein grouping, based on the respective slopes and locations of the plurality of wells, each well into a respective cluster comprises:
designating each well as a separate cluster; and
until a stopping condition is reached, iteratively:
calculating a respective proximity matrix of each separate cluster with respect to the other separate clusters based on Euclidean distance; and
using a modified clustering algorithm to merge the two most similar separate clusters.

18. The system of claim 17, wherein the stopping condition is exceeding a pressure threshold within each separate cluster for a defined time-step.

19. The system of claim 17, wherein using a modified clustering algorithm to merge the two most similar separate clusters comprises:
calculating similarities between each pair of separate clusters;
determining, based on the calculated similarities, the two most similar separate clusters; and
merging the two most similar separate clusters to form a new cluster.

20. The system of claim 16, the operations further comprising:
generating a reservoir map indicative of each separate compartment in the gas reservoir; and
displaying the reservoir map on a display device.
